(19) United States
(12) Patent Application Publication
(10) Pub. No.: US 2006/0065771 A1
(43) Pub. Date: Mar. 30, 2006

(54) Seatbelt retracting method

(75) Inventors: Masato Takao, Hikone-shi (JP); Koji Tanaka, Moriyama-shi (JP); Koji Inuzuka, Echi-gun (JP)

Correspondence Address: FOLEY AND LARDNER LLP;SUITE 500, 3000 K STREET NW, WASHINGTON, DC, 20007, US

(73) Assignee: TAKATA CORPORATION

(21) Appl. No.: 11/206,107

(22) Filed: Aug. 18, 2005

(30) Foreign Application Priority Data
Sep. 24, 2004 (JP) 2004-276552

(51) Int. Cl. B60R 22/46

(52) U.S. Cl. 242/374; 280/807

(57) ABSTRACT

A seatbelt retracting method can retract the entire quantity of a seatbelt even when the seatbelt is unintentionally engaged with something during retraction of the seatbelt. When a time from engagement between a buckle and a tongue of the seatbelt is released and a motor starts retraction until it stops for a first time is equal to or exceeds a first predetermined value, a state in which retraction is stopped is maintained, and when the time from the motor starts retraction until it stops for the first time is smaller than the first predetermined value, the retracting operation is restarted every time when the retracting operation is stopped until a total time of retracting operation carried by the motor reaches or exceeds a second predetermined value.

### BACKGROUND

The present invention relates to a seatbelt retracting method in a seatbelt retracting apparatus having a function of retracting a seatbelt by a motor, in which a retracting operation is stopped when a load of the motor (except for an accelerating load) reaches or exceeds a predetermined value.

In a seatbelt retracting apparatus, it is required to comply simultaneously with the following conditions.
(1) To retract the seatbelt which is excessively pulled out positively until it fits a human's body, or when it is not worn by the human, to retract the seat belt, which is pulled out positively until it is stored in a storage; and
(2) To prevent chest regions of a passenger from being applied with unnecessary feeling of pressure in a state of normally worn.

However, in the seatbelt retracting apparatus using an urging force of a single return spring, there is a problem such that when a spring which provides a weak urging force is used for reducing the feeling of pressure applied to the chest regions of the passenger when it is worn, a retracting force when retracting the belt (when storing the belt) is reduced, and hence operability and storability are lowered. In contrast, when a spring which provides a strong urging force is used for demonstrating an excessive retracting force during retraction, the feeling of pressure applied to the chest regions of the passenger when it is normally worn may increase.

As a method of solving such a problem, an invention of a seatbelt retracting apparatus which retracts a seatbelt by a motor in addition to a retracting force by a return spring is disclosed for example in Japanese Unexamined Patent Application Publication No. 3-552 and Japanese Unexamined Patent Application Publication No. 2001-225720 (both of which are hereby incorporated by reference herein in their entirety).

In this manner, when the seatbelt is retracted by the motor, the following matters must be taken into consideration.
(1) To stop power supply to the motor when the entire quantity of the seatbelt is completely retracted (to stop the retracting operation). Otherwise, not only a battery power is uselessly consumed since unnecessary electric current is supplied to the motor, but also the motor to be used must be the type which is not overheated even though heavy current is used for a long time.
(2) To stop power supply to the motor (to stop the retracting operation) when the seatbelt is unintentionally engaged with something, or when the operation to pull out the seat belt is carried out by the passenger when the seatbelt is retracted. Otherwise, the battery power is uselessly consumed since unnecessary electric current is supplied to the motor, or the seatbelt pulling-out operation by the passenger is resisted by a large resistance force, and hence a sense of discomfort may be applied.

In order to prevent occurrence of such a problem, in the seatbelt retracting control apparatus in the related art, a control, such as to detect the electric current to be supplied to the motor, and when a detected current value exceeds a predetermined value, determines that the condition is in the state of aforementioned (1) or (2), and stop power supply to the motor (stop the retracting operation) has been carried out.

### SUMMARY

One embodiment of the present invention relates to a seatbelt system. The seatbelt system comprises a seatbelt with a buckle and a tongue, a retractor with a motor configured to retract the seatbelt, and a controller configured to control the motor. The retractor is configured to retract an entire quantity of the seatbelt even when the seatbelt is unintentionally engaged and stops retracting. The motor is configured to stop a retracting operation when a load of the motor (except for an accelerating load) reaches or exceeds a predetermined value. When a time from which the motor starts retraction, due to disengagement between the buckle and the tongue of the seat belt, until the motor stops retraction for the first time is equal to or exceeds a first predetermined value, a state of stopped retraction is maintained. When the time from which the motor starts retraction until it stops for the first time is smaller than the first predetermined value, the retracting operation starts again every time when the retracting operation is stopped until a total time of the retracting operation carried out by the motor reaches or exceeds a second predetermined value.

Another embodiment of the invention relates to a seatbelt retracting method in a seatbelt retracting apparatus. The method comprises retracting a seatbelt by a motor, and stopping a retracting operation when a load of the motor (except for an accelerating load) reaches or exceeds a predetermined value. When a time from which the motor starts retraction, due to disengagement between a buckle and a tongue of the seat belt, until the motor stops retraction for the first time is equal to or exceeds a first predetermined value, a state of stopped retraction is maintained. When the time from which the motor starts retraction until it stops for the first time is smaller than the first predetermined value, the retracting operation starts again every time when the retracting operation is stopped until a total time of the retracting operation carried out by the motor reaches or exceeds a second predetermined value.

According to another embodiment of the present invention, a seatbelt retracting method is provided. The method comprises: (a) determining if a seatbelt buckle and tongue are released; (b) retracting a seatbelt; (c) stopping retraction of the seatbelt for a first time; (d) determining a retraction position of seatbelt by determining elapsed time between steps (b) and (c); and (e) stopping retraction operation if the elapsed time is greater than or equal to a first predetermined time value or restarting retraction to continue retracting the seatbelt if the elapsed time is less than the first predetermined time value.

It is to be understood that both the foregoing general description and the following detailed description are exemplary and explanatory only, and are not restrictive of the invention as claimed.

### BRIEF DESCRIPTION OF THE DRAWINGS

These and other features, aspects, and advantages of the present invention will become apparent from the following description, appended claims, and the accompanying exemplary embodiments shown in the drawings, which are briefly described below.

FIG. 1 is a flowchart showing a seatbelt retracting method as an example of an embodiment of the present invention.

FIG. 2 is a schematic view of a seatbelt system with a retractor.

### DETAILED DESCRIPTION

There is a problem such that when power supply to the motor is stopped (retracting operation is stopped) when the seatbelt is unintentionally engaged with something during retraction of the seatbelt, the entire quantity of the seat belt is not retracted completely and remains unretracted.

In view of such circumstances, it is an object of an embodiment of the present invention to provide a seatbelt retracting method which can retract an entire quantity of a seatbelt even when the seatbelt is unintentionally engaged with something during retraction of the seatbelt.

A first means, according to an embodiment of the present invention, to solve the aforementioned problem is a seatbelt retracting method in a seatbelt retracting apparatus having a function to retract a seatbelt by a motor, in which a retracting operation is stopped when a load of the motor (except for an accelerating load) reaches or exceeds a predetermined value, wherein when a time from the motor starts retraction due to disengagement between a buckle and a tongue of the seat belt until it stops for the first time is equal to or exceeds a first predetermined value, a state in which the retraction is stopped is maintained, and when the time from the motor starts retraction until it stops for the first time is smaller than the first predetermined value, the retracting operation starts again every time when the retracting operation is stopped until a total time of retracting operation carried out by the motor reaches or exceeds a second predetermined value.

In an embodiment of the present invention, when the first predetermined value is set to a time required until the seatbelt is completely stored when the normal retracting operation is carried out, or a time slightly shorter than that. Accordingly, when the normal retraction is carried out and the seatbelt is completely or almost completely stored, the state as is (the state in which the motor is kept stopped) is maintained.

When the time required until the motor stops for the first time is shorter than the first predetermined value, it is determined that the motor is stopped before the retraction is completed under an abnormal condition such as unintended engagement of the seatbelt or the like. Then, the retraction of the seatbelt is restarted. In this case, the retracting operation is restarted every time when the retracting operation is stopped until the total time of retracting operation carried out by the motor reaches or exceeds the second predetermined value.

The second predetermined value may be the same as the first predetermined value. However, when acceleration or deceleration of the motor is taken into consideration, it may be the time until the seatbelt is completely stored, or the time slightly shorter than that. Accordingly, the retracting operation is repeated until the seatbelt is completely, or almost completely stored.

A second means, according to an embodiment of the present invention, for solving the aforementioned subject is the first means, wherein the first predetermined value and the second predetermined value are changed in accordance with an electric current flowing in the motor.

When a voltage applied to the motor is constant, a constant relation is established between the current flowing in the motor and the motor speed. In other words, when the electric current flowing in the motor is large, a rotational speed of the motor is low, and when the electric current flowing in the motor is small, the rotational speed of the motor is high. Therefore, by varying the first predetermined value and the second predetermined value according to the electric current flowing in the motor, the retracting operation of the motor can be carried out accurately until the seatbelt is completely or almost completely stored.

According to embodiments of the present invention, the seatbelt retracting method in which the entire quantity of the seatbelt can be retracted even when the seatbelt is unintentionally engaged with something during retraction of the seatbelt can be provided.

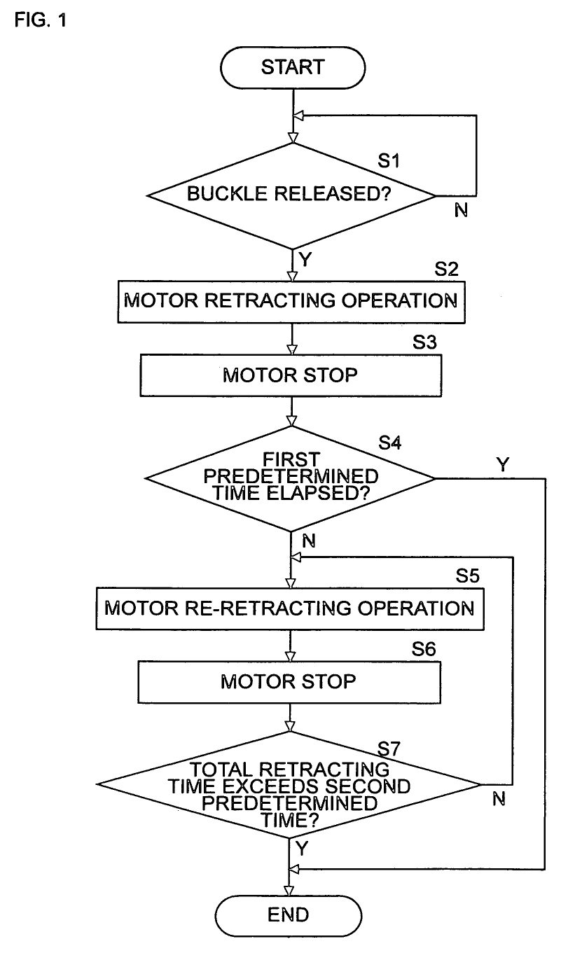

Referring now to the drawings, an embodiment of the present invention will be described. FIG. 1 is a flowchart showing a seatbelt retracting method as an example of the embodiment of the present invention.

In Step S1, whether or not engagement between a buckle and a tongue of a seatbelt is released is determined. In the case in which the engagement is not released, the procedure goes back to Step S1 and waits until the engagement is released.

When the engagement between the buckle and the tongue is released, the procedure goes to Step S2, where retraction of the seatbelt is started. In other words, a seatbelt retracting motor is driven. When retraction of the seatbelt is completed, or when unintended engagement of the seatbelt occurs, the motor stops. The stop of the motor can be detected by detecting a load current flowing in the motor. In this case, driving of the retracting motor is stopped once as described above (Step S3).

When the motor is stopped, the procedure goes to Step S4, where whether or not a first predetermined time has elapsed since the retraction of the seat belt has started is determined. The first predetermined time here is a time required until the seatbelt is completely stored when normal retraction is carried out, or a time slightly shorter than this period. When the first predetermined time has elapsed, it is determined that the retraction of the seatbelt is almost completed, and the procedure is ended.

When the first predetermined time is not elapsed, the step goes to Step S5, and the retracting operation of the motor is started again. Again, when the retraction of the seatbelt is completed, or when unintended engagement of the seatbelt occurs, the motor stops (Step S6).

In this case, the procedure goes to Step S7, and whether or not the total retracting time (total sum of the motor driving time) from the time when the retraction of the seatbelt is started reaches or exceeds a second predetermined time is determined. When the total retracting time does not reach the second predetermined time, the procedure goes back to Step S5, where the retracting operation of the motor is started again.

When the total retracting time reaches the second predetermined time, it is determined that the retraction of the seatbelt is carried out almost completely, and the procedure is ended. Here, the second predetermined time is set to the same as the first predetermined time, or when acceleration or deceleration of the motor is considered, it is set to the time required until the seatbelt is completely stored or the time slightly shorter than this time.

It is also possible to define the first predetermined time and the second predetermined time as a function of electric current flowing in the motor. Since driving of the motor is achieved by applying a constant voltage, a stationary current flowing in the motor (except for accelerating current, decelerating current) is taken into consideration to have a constant relation with respect to the motor speed. Therefore, by defining the first predetermined time and the second predetermined time as the function of the electric current flowing in the motor, whether or not the seatbelt is retracted almost completely can be detected more accurately. Measurement of the electric current of the motor and definition of the first predetermined time and the second predetermined time are carried out, for example, by measuring electric current during retraction of the motor in Step S2.

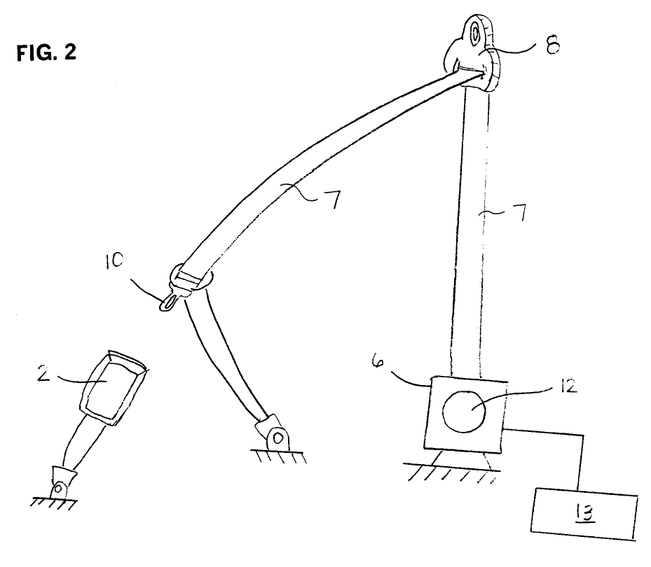

According to another embodiment, a seatbelt system is provided. The seatbelt system, as can be seen in FIG. 2, includes a seatbelt 7 with a buckle 2 and a tongue 10. The seatbelt 7 can slide through a belt guide 8. The seatbelt system further includes a retractor 6 with a motor 12 and a controller 13. The controller 13 can control the motor 12.

Japan Priority Application 2004-276552, filed Sep. 24, 2004 including the specification, drawings, claims and abstract, is incorporated herein by reference in its entirety.

Given the disclosure of the present invention, one versed in the art would appreciate that there may be other embodiments and modifications within the scope and spirit of the invention. Accordingly, all modifications attainable by one versed in the art from the present disclosure within the scope and spirit of the present invention are to be included as further embodiments of the present invention. The scope of the present invention is to be defined as set forth in the following claims.

What is claimed is:

1. A seatbelt system, comprising:
a seatbelt with a buckle and a tongue;
a retractor with a motor configured to retract the seatbelt; and
a controller configured to control the motor,
wherein the retractor is configured to retract an entire quantity of the seatbelt even when the seatbelt is unintentionally engaged and stops retracting,
wherein the motor is configured to stop a retracting operation when a load of the motor (except for an accelerating load) reaches or exceeds a predetermined value,
wherein when a time from which the motor starts retraction, due to disengagement between the buckle and the tongue of the seat belt, until the motor stops retraction for the first time is equal to or exceeds a first predetermined value, a state of stopped retraction is maintained, and
wherein when the time from which the motor starts retraction until it stops for the first time is smaller than the first predetermined value, the retracting operation starts again every time when the retracting operation is stopped until a total time of the retracting operation carried out by the motor reaches or exceeds a second predetermined value.

2. The seatbelt system according to claim 1, wherein the first predetermined value and the second predetermined value are changed in accordance with an electric current flowing in the motor.

3. The seatbelt system according to claim 1, wherein the second predetermined value equals the first predetermined value.

4. The seatbelt system according to claim 1, wherein the first predetermined value equals a time required to completely store the seatbelt.

5. A seatbelt retracting method in a seatbelt retracting apparatus comprising:
retracting a seatbelt by a motor, and
stopping a retracting operation when a load of the motor (except for an accelerating load) reaches or exceeds a predetermined value,
wherein when a time from which the motor starts retraction, due to disengagement between a buckle and a tongue of the seat belt, until the motor stops retraction for the first time is equal to or exceeds a first predetermined value, a state of stopped retraction is maintained, and
wherein when the time from which the motor starts retraction until it stops for the first time is smaller than the first predetermined value, the retracting operation starts again every time when the retracting operation is stopped until a total time of the retracting operation carried out by the motor reaches or exceeds a second predetermined value.

6. The seatbelt retracting method according to claim 5, wherein the first predetermined value and the second predetermined value are changed in accordance with an electric current flowing in the motor.

7. The seatbelt retracting method according to claim 5, wherein the second predetermined value equals the first predetermined value.

8. The seatbelt retracting method according to claim 5, wherein the first predetermined value equals a time required to completely store the seatbelt.

9. A seatbelt retracting method, comprising:
(a) determining if a seatbelt buckle and tongue are released;
(b) retracting a seatbelt;
(c) stopping retraction of the seatbelt for a first time;
(d) determining a retraction position of seatbelt by determining elapsed time between steps (b) and (c); and
(e) stopping retraction operation if the elapsed time is greater than or equal to a first predetermined time value or restarting retraction to continue retracting the seatbelt if the elapsed time is less than the first predetermined time value.

10. The seatbelt retracting method according to claim 9, further comprising:
(f) stopping retraction for an additional time after restarting retraction.

11. The seatbelt retracting method according to claim 10, further comprising:
(g) determining position of the seatbelt by determining total elapsed time between steps (b)-(c) and (e)-(f).

12. The seatbelt retracting method according to claim 11, further comprising:
(h) stopping retraction if the total elapsed time is greater than or equal to a second predetermined time value or repeating steps (e)-(g) until the total elapsed time is greater than or equal to the second predetermined time value.

13. The seatbelt retracting method according to claim 12, wherein the second predetermined time value equals the first predetermined time value.

14. The seatbelt retracting method according to claim 9, wherein the first predetermined time value equals time to completely store the seatbelt.
